(19) United States
(12) Patent Application Publication
(10) Pub. No.: US 2025/0328384 A1
(43) Pub. Date: Oct. 23, 2025

(54) SPARSE PROCESSING UNIT

(71) Applicant: Applied Physics, Inc., New York, NY (US)

(72) Inventors: Gianni Martire, New York, NY (US); Haydn Kirk Vestal, Austin, TX (US)

(21) Appl. No.: 19/187,683

(22) Filed: Apr. 23, 2025

Related U.S. Application Data
(60) Provisional application No. 63/637,467, filed on Apr. 23, 2024.

(51) Int. Cl. G06F 9/50

(52) U.S. Cl. CPC G06F 9/5011; G06F 9/5022

(57) ABSTRACT

A sparse processing unit (SPU) can utilize an onboard memory management unit (MMU), and a cluster of parallel processors to increase the efficiency of processing of sparse workloads. The MMU maps an n-dimensional sparse address space, related to the sparse input, intermediary or output sparse data, to a one-dimensional physical memory layout. The SPU can be added to a host computer system, freeing up the host from having to perform memory management functions for accelerating the processing of the sparse workloads.

### CROSS-REFERENCE TO RELATED APPLICATIONS

This application claims the benefit of priority to U.S. Provisional Application No. 63/637,467, filed on Apr. 23, 2024, and titled “SPARSE PROCESSING UNIT,” which is hereby incorporated by reference in its entirety.

### BACKGROUND

### Field

This invention relates generally to the field of hardware processing units, and more particularly to processing units designed for accelerating the processing of sparse workloads.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Hardware accelerators have been used to increase the efficiency of a computer system in specific processing tasks. For example, graphics processing units (GPUs) have been used to increase the efficiency of a computer system in processing video frames. M any such accelerators are optimized for parallel processing of structured data. For example, tensor processing units (TPUs) are designed for performing matrix multiplication, in parallel, on large sets of artificial intelligence data. Existing accelerators, such as GPUs or TPUs operate more efficiently on dense data structures, or dense workloads. Real-world applications, however, typically correspond to and are represented better with sparse data structures. While sparse workloads can be processed with existing hardware accelerators, their sparsity can introduce challenges and inefficiencies to existing hardware accelerators. For example, one technique for processing a sparse workload includes generating a dense workload from a sparse workload by populating the missing data structure elements with a zero or null character, and then processing the dense data structure with an existing hardware accelerator. After processing, the output can go through post processing to remove the zeros or null elements to produce a sparse output, corresponding to the initial sparse input.

Sparse workloads also present a challenge for the existing hardware accelerators in terms of memory management since, unlike dense workloads, the size of the output of a sparse workload can be unknown prior to processing the workload. This can force an existing accelerator, and a host device, to inefficiently perform and re-perform some processing steps when executing a sparse workload. Consequently, there is a need for robust hardware accelerators that address the challenges of processing sparse workloads.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1 illustrates dense and sparse data structures, for example, tensors and some associated operations.

FIG. 2 is a diagram of an example computer system utilizing a CPU.

FIG. 3 illustrates a logical layout block diagram of the operations of a kernel, such as a GPU kernel, used in processing artificial intelligence workloads.

FIG. 4 illustrates a block diagram of an example hardware layout of a GPU.

FIG. 5 illustrates a logical block diagram of an example sparse processing unit (SPU), according to an embodiment.

FIG. 6 illustrates a physical layout diagram of an example sparse processing unit (SPU), according to an embodiment.

FIG. 7 illustrates a logical layout diagram of a workstation, where a computer system utilizes a cluster of SPUS.

FIG. 8 illustrates a flowchart of an example method of processing a sparse workload in an SPU-enabled computer system.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Graphics Processing Units (GPUs) were initially designed for rendering 2D-pixel matrices on screens and have been adapted for machine learning, although they are limited to dense vector and matrix operations due to their original design. Today's artificial intelligence (AI) industry is built around these limitations, but as various modern businesses seek Artificial General Intelligence, they will require hardware for neural architectures resembling the human connectome, which is extremely sparse. GPUs' inefficiency with truly sparse workloads, such as vector databases and topologically augmented neural networks, creates the opportunity for the Sparse Processing Unit (SPU), designed for these specific tasks, including accelerating the ResNet architecture used by DeepSNR as well as algorithms for vector and graph database search and clustering.

This can be understood in the context of the evolution of the GPUs from 1970s video games to current applications in parallel computing, including machine learning. Introduction of generic stream processing units marked a shift towards general-purpose computing which became driven by cryptocurrency mining, leading to the development of application-specific integrated circuits (ASICs) for crypto mining and machine learning. Tensor Processing Units (TPUs), designed for dense sequential neural networks, proved, incontrovertibly, the cost and efficiency advantages of ASICs for machine learning.

### Dense and Sparse Workloads

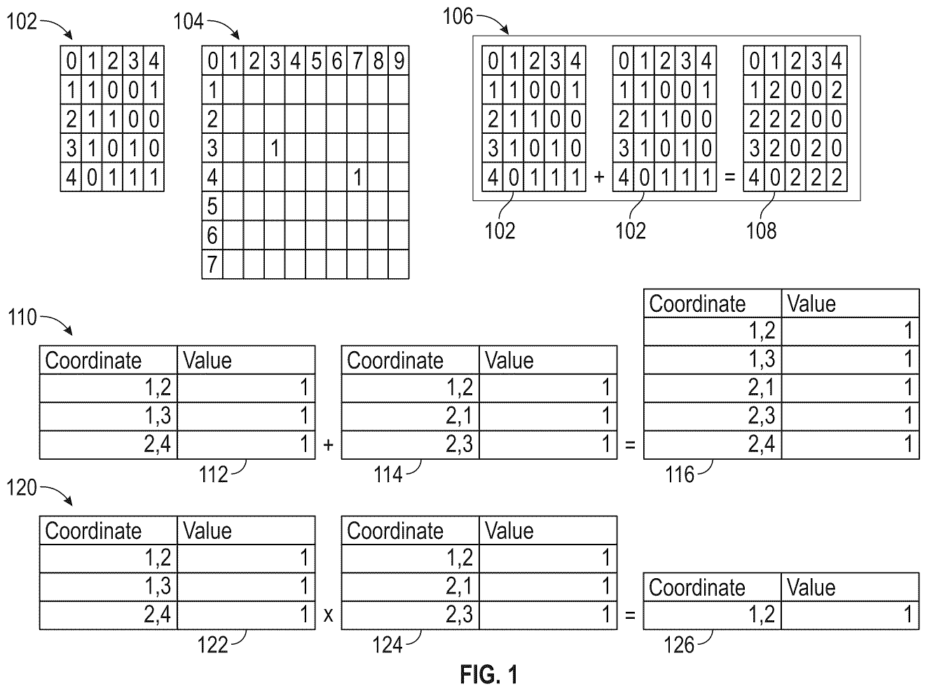

FIG. 1 illustrates dense and sparse data structures, for example tensors and some associated operations. Diagram 102 illustrates an example of a dense tensor. An n-dimensional dense tensor has a value assigned to every address within its n-dimensional address space. For example, an uncompressed standard-definition black-and-white image is a two-dimensional dense tensor of shape [480, 360] whose values are a measure of brightness. An uncompressed standard definition color image is a dense tensor of shape [480, 360, 3] whose values are a measure of hue. GPUs were originally developed to enable a computer to generate a video signal in real-time. This is why a GPU kernel has specifically a three-dimensional virtual memory address space.

Diagram 104 illustrates an example of a sparse tensor. An n-dimensional sparse tensor does not have values assigned to every address in its address space. Typically, a sparse tensor has less than 50% of its address space occupied, and often much less than 1%. For example, the connectome of the human brain can be represented as an adjacency matrix with 86 billion rows and columns and less than 1 in 1000 addresses filled.

The result of a dense operation can always be calculated from the dimensions of the input data. This is why GPUs and TPUs, SIM D processors designed to accelerate dense workloads, do not support memory management, instead requiring the host to allocate and deallocate the virtual memory used by the kernel running on the device. Because the data is dense, the host can easily allocate memory for the result of any number of operations in advance of enqueueing them to run on the device. However, the size of the result of a sparse operation cannot be known in advance of performing the operation. Consider the “addition operation” shown in diagram 106. The dense tensor 102 can be added to itself, resulting in tensor 108. The size of the result, such as the tensor 108, can be anywhere between 0 and the sum of the sizes of the operands (the dense tensor 102 in this example). This variability increases with each step of a multi-operation kernel.

Since GPUs and TPUs are designed such that memory management can only be performed by the host, sparse operations cannot be efficiently implemented on a GPU or TPU. Since memory management is performed by the host, each operation may require multiple data transfers between the GPU or TPU device. In some cases, the latency of the transfers can outweigh the acceleration gains obtained from deploying GPU or TPU devices, obviating the usage of accelerator devices, such as GPUs and TPUs. In the following sections, a brief overview of various hardware devices and their performance when processing sparse workloads will be discussed.

### Central Processing Unit (CPU)

A central processing unit (CPU) is a general-purpose multiple-instruction/multiple-data (MIMD) chip which has multiple “cores” each of which can execute one instruction at a time, so 1-2 threads can run concurrently on each core. A CPU has several levels of physical memory divided by physical distance on the board. Most data resides in main memory, a separate dynamic random access memory (DRAM) chip, but a CPU chip is designed with L1, L2, and often L3 or even L4 cache, physical memory circuits, integrated into the chip itself, such that L1 has a very small capacity and only supports a single core but access is practically instantaneous. L2 stores a larger amount of data with slightly slower access shared between all cores, etc.

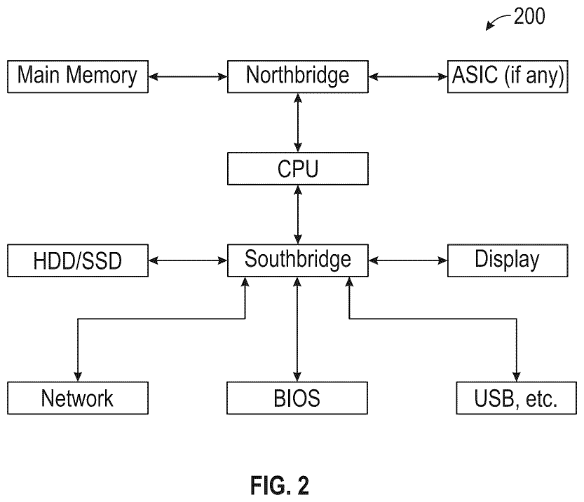

Practically all CPUs implement time-division multitasking, so an unlimited number of logical threads can run on a single CPU, and the CPU will “context-switch” between them potentially thousands of times per second so that to a human user they appear to all be running concurrently. A computer system requires at least one CPU but may have more. Some peripheral devices may have their own CPUs, typically with much lower capacity than the host CPU. A CPU can run any possible computer program, to the point that one CPU can be programmed to simulate any other CPU. FIG. 2 is a diagram of an example computer system 200 utilizing a CPU. A CPU is typically not efficient in performing parallel operations of dense or sparse workloads, compared to other devices. For example, GPUs and TPUs can include many more parallel processing cores to perform parallel operations. As a result, CPUs use GPUs and TPUs, as accelerators, to speed up the processing of workloads that can benefit from, such dedicated hardware components. In the example computer system 200, the CPU has access to a main memory, via a first interface, for example, a northbridge, and one or more ASIC chips. The northbridge is one of the two chips, implementing the core logic chipset architecture on a motherboard (the other being a slower southbridge). The northbridge can be directly connected to a CPU, via a front-side bus (FSB), to handle high performance tasks, usually used in conjunction with a slower southbridge to manage communication between the CPU and other components or parts of the motherboard. In other implementations of a computer system, the northbridge and/or southbridge functionality and components can be merged with other components, where northbridge and/or southbridge as distinct components can be eliminated. For example, in some implementations, the northbridge and southbridge components and functionality are integrated into the CPU, eliminating the need for the bridges. The various components of the computer system 200 can be mounted on a motherboard, main circuit board, logic board, system board or similar, where such boards hold, connect and provide communication pathways for the various components of the computer system 200.

Furthermore, the CPU has access to a permanent storage, and an output device, via a second interface, for example, a south bridge. An example of a permanent storage is a hard drive device (HDD), or solid state device (SSD). An example of an output device is a display device. The south bridge can also provide access to a communication interface for accessing a network. The south bridge can also provide access and interface to a basic input/output system (BIOS), and other peripherals, such as universal serial bus (USB) devices. The components shown are provided as examples. In other implementations of a CPU, similar or same components can be integrated on-chip, or eliminated, depending on the application of the CPU. Other components, not shown, can also exist.

### GPU

A graphics processing unit (GPU) is a single instruction/multiple data (SIM D) chip which has millions or billions of cores which can each operate on independent data but can only execute one instruction at a time. The following single integer addition operation on four data in parallel [1, 2, 3, 4]+[8, 7, 6, 5]=[9, 9, 9, 9] is an example of a kind of operation that can be performed by a GPU. A GPU can perform millions or billions of such operations in parallel.

A GPU is a “parallel processor” in the sense that it operates on multiple data in parallel. This is distinct from a multi-core CPU, which can run multiple threads concurrently (i.e. not limited to only one instruction on all data). Because of their graphics-focused design heritage, GPUs typically include hardware components such as vertex shaders, video BIOS, hardware 2D and 2D geometry renderers, texture & lighting pipelines, etc., which are not utilized by non-graphics workloads such as machine learning.

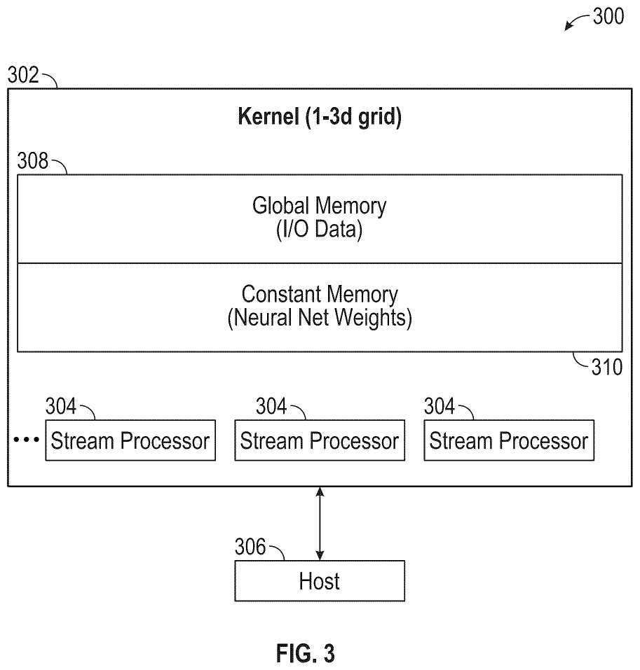

A GPU kernel typically relies on its host for memory management operations. In other words, the GPU does not perform on-board memory management. Memory management in this context refers to allocating and deallocating physical and/or virtual memory for the processing operations. FIG. 3 illustrates a logical layout block diagram 300 of the operations of a kernel 302, such as a GPU kernel, used in processing artificial intelligence workloads.

The kernel 302 utilizes a plurality of stream processors 304 to process a workload. The kernel 302 relies on a host 306 to perform memory management operations. The host 306 in this context can be a computer system. For example, the kernel 302 can run on a GPU, installed on a motherboard in a computer system, similar to the computer system 200. The host 306 can have one or more CPUs, random access memory (DRA M), permanent storage devices, such as a hard drive, communication devices, peripheral devices, and/or other components. The GPU does not include any memory management devices and relies on the host 306 to perform memory allocation and deallocation. The host 306 utilizes a global memory 308 and/or a constant memory 310 for the operations of the kernel 302. The global memory 308, and/or the constant memory 310 can be implemented in a random-access memory, for example, a DRAM, in the host 306. The global memory 308 and constant memory 310, are therefore outside the GPU, and in the host 302. The allocation, deallocation or memory management is performed by the host 306. Since the block diagram 300 is a logical block diagram, the global memory 308 and constant memory 310 are shown in the kernel 302. Nevertheless, the global memory 308 and constant memory 310 can be physically located in the host 306, and are managed by the host 306.

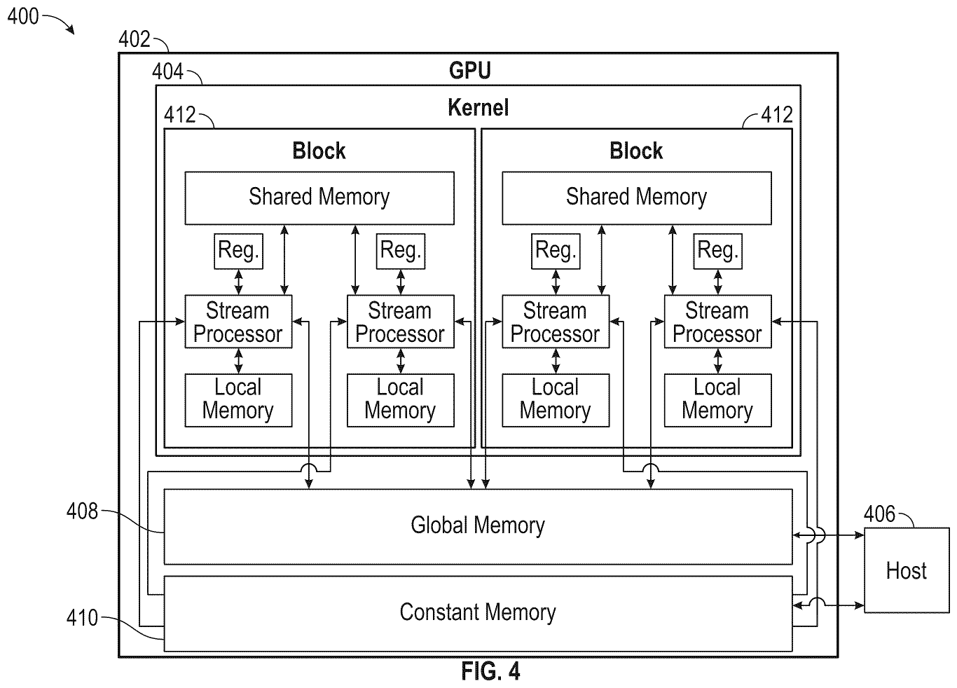

FIG. 4 illustrates a block diagram 400 of an example hardware layout a GPU 402. The GPU can run a GPU kernel, or a kernel 404. The kernel 404 can include one or more blocks 412 for performing parallel operations. Each block 412 can include multiple stream processors. Each stream processor can have its dedicated register and local memory. Each block can include a shared memory that is used by all or some of its stream processors. The stream processors read and write to the global memory 408 and constant memory 410. The physical and/or virtual memory management operations are performed by the host 406.

### TPU

A tensor processing unit (TPU) is a device designed by Google® specifically to accelerate machine learning workloads. TPUs do not include graphics support components. This allows for much higher performance per-watt from a much simpler device. Similar to a GPU, a TPU does not have its own on-device memory. It supports only one operation, which is systolic matrix multiplication, the fundamental operation of a neural network. A “TPU Pod,” i.e. many TPUs connected to the same host, is able to match the performance of a supercomputer for dense neural network workloads at a tiny fraction of the cost.

The lack of on-board memory management in accelerator devices, such as GPUs and TPUs, particularly in the context of processing sparse workloads can lead to various inefficiencies, as the workload, and intermediate operation results, may have to be transferred back and forth between the accelerator and the host 406 to determine the memory allocation of a subsequent operation. In the context of dense workloads, these inefficiencies are less pronounced, or not present, because the deterministic nature of the dense workloads can allow for memory allocation by the host prior to execution of the workload. For example, since the size of the output of a matrix multiplication of a dense workload can be known beforehand, the host can allocate the required memory before loading the GPU with data for matrix multiplication. In the context of sparse data, the size of the output or intermediary outputs are unknown. Therefore, the host 406 cannot efficiently perform memory allocation in advance.

### Sparse Processing Unit (SPU)

A sparse processing unit (SPU) is a proposed class of device, which can accelerate sparse workloads. An SPU can be a device, mountable on a computer system motherboard. In other implementations, one or more SPUs can be integrated into another component, such as a motherboard, or similar component. The SPU has an integrated hardware scheduler, memory management unit, and parallel processors for accelerating programs which process sparse data. Examples of sparse data can include vector databases, graph databases, and topology and weight-evolving neural networks, i.e. neural networks which support connections between neurons in non-adjacent layers and do not require “zeroing out” the weights of disconnected neurons in adjacent layers (as in a highway neural net). The SPU includes an on-device sparse memory manager, which allows a kernel running on the scheduler to allocate and deallocate memory as-needed and performs incremental sorting on results to minimize access time. The SPU allows a kernel running on a parallel processor to address its virtual memory, without time-consuming bounds-checking.

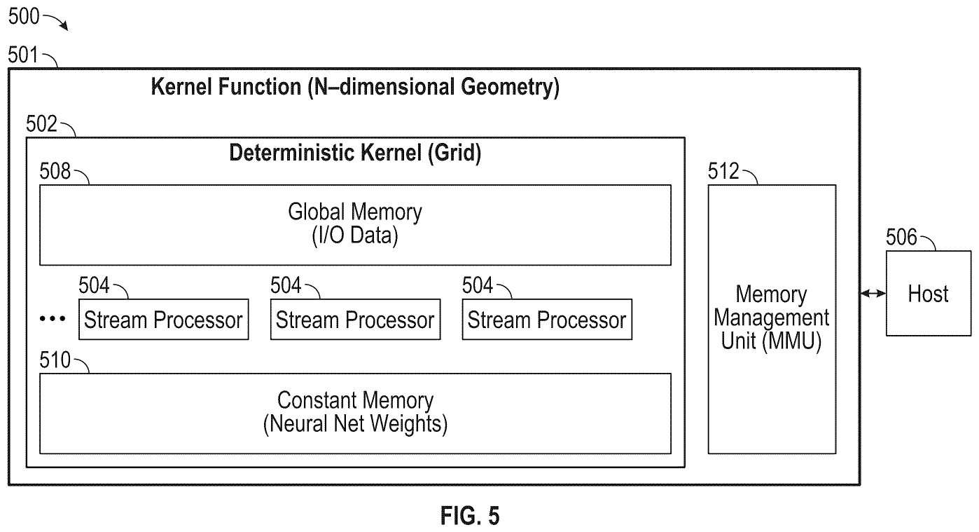

FIG. 5 illustrates a logical block diagram 500 of an example sparse processing unit (SPU), according to an embodiment. The SPU includes a kernel functional 501. The kernel functional 501 is a higher order function that operates on deterministic kernels 502. Kernel functionals allow for composite operations that include memory management and conditional execution changes, within a single operation. Kernel functionals, therefore, can provide for efficient processing of sparse data. Kernel functional 501 can be an outer kernel to one or more deterministic kernels 502. In other words, the kernel functional 501 can call and execute one or more deterministic kernels 502. The term “deterministic,” in this context, indicates that for the same number of input data, the kernel will always require the same number of processing cycles to execute and process the input data. A deterministic kernel 502 can be expressed in a dense data structure, for example in a grid of the size of the dense data structure, or a tensor of the size of the dense data structure. In other words, the instruction embedded in a deterministic kernel 502 can be expressed in a grid data structure, based on its input and/or output data. By contrast, a kernel functional 501 can be of any arbitrary dimensions (an n-dimensional geometry), based on the sparse workload to which the kernel functional relates.

The kernel functional 501 can include an on-chip memory management unit (MMU) 512. The MMU 512 maps a sparse virtual memory address space to a real physical memory address space on global memory 508 and/or constant memory 510.

The deterministic kernel 502 can include the same logical components as described in relation to the kernel 302, and 402. For example, the deterministic kernel 502 can include stream processors 504. The deterministic kernel 502 can interface with a global memory and/or a constant memory, for example, it can read from and write into a global memory 508 and/or a constant memory 510. The deterministic kernel 502 can be in communication with a host 506. The host 506 can be a CPU and/or a computer system. Input data can be provided by the host 506 and the output of the kernel functional 501 and/or the deterministic kernel 502 can be provided to the host 506.

Using the kernel functional 501 can enable various efficiencies and allow for fusion of operations, eliminating or reducing the need to transfer data to and from the host 506. For example, using a kernel functional 501, the SPU can perform multiple operations, including memory management and conditional execution changes, in a single step without needing to wait for input/output operations with a host 506. The ability to fuse operations in a compute graph can enable the SPU to avoid the overhead of recalculating memory offsets for each operation, a significant efficiency improvement over the GPUs and/or TPUs.

An example application of kernel functional includes deploying SPUs in graph-based computations, such as breadth-first graph traversal. Graph-based computations are in used various computer science domains, including database queries, financial applications, and natural language processing. Another example application of kernel functional includes deploying SPUs for efficient high-dimensional data searches. An example includes searches utilizing a vector nearest-neighbor search. Such searches are performed in computer-based, or AI-based recommendation systems, clustering and other examples. Kernel functionals and SPUs, utilizing them, can be deployed for neuro-evolution of augmenting topologies (NEAT), which is an example of an area of technology, where SPUs can facilitate alternate neural network architectures, in which the topology of the network itself is optimized by the training process, rather than just the weights.

Compared to a CPU, an SPU can run one thread at a time, operating on an array of data in parallel, while a CPU runs one to two threads concurrently on each of its cores. Compared to a GPU, an SPU can be built around a parallel processor, which carries out basic arithmetic on n-dimensional arrays; but unlike a GPU, an SPU does not require its host to perform memory management and performs memory management on board. An SPU kernel allocates memory dynamically to store results and allows deterministic kernels 502 to address a sparse address space as if it were dense, while a GPU kernel, without a higher order kernel functional, requires all needed memory to be pre-allocated by its host and must explicitly compute a linear map between a one-to three-dimensional virtual memory address space and an n-dimensional array (e.g., a tensor) address space.

Similar to a TPU, an SPU can be implemented as an application-specific integrated circuit (ASIC). Regardless of hardware implementation, an SPU can accelerate n-dimensional array workloads, such as the vector and matrix processing done by machine learning applications. Unlike a TPU, an SPU not only has integrated (on-device) memory, but also has an on-device memory management unit (MMU) 512, which can support a sparse n-dimensional virtual memory address space.

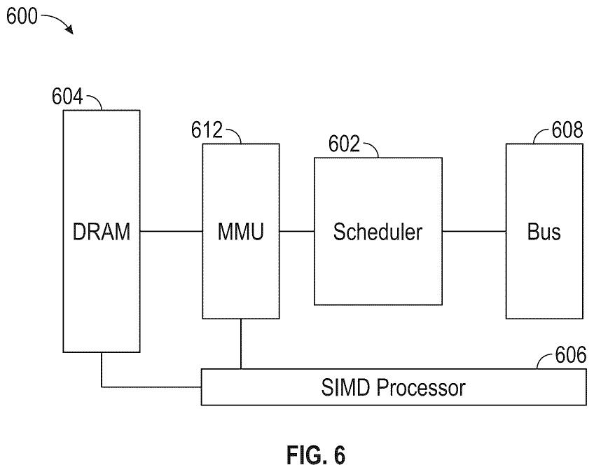

FIG. 6 illustrates a physical layout diagram 600 of an example sparse processing unit (SPU), according to an embodiment. For clarity of illustration, low-level electrical traces are omitted. The kernel functional runs on the scheduler 602. In some embodiments, the scheduler 602 can be implemented by a reduced instruction set computer (RISC). It can include a CPU, albeit at much less capacity than a CPU used by a host. The scheduler is the processor that operates the MMU. The kernel functional, running on the scheduler can perform memory allocation. In other words, the kernel functional, running on the scheduler can direct the MMU to perform memory management. The MMU can address the global and local memories in a DRAM 604, based on the programming in the kernel functional and the operations therein. The kernel functional can call deterministic kernels (e.g., deterministic kernels 502). Once called, the deterministic kernels execute on the SIM D processor 606. For example, the MMU can call a deterministic kernel 502, and provide memory addresses for its input and output, while in the background the MMU keeps track of, and manages a mapping of the memory addresses provided to the deterministic kernel 502, relative to a sparse address space of input and output data. The components of the SPU 600 can be in communication with one another and/or an external component, for example a host (not shown), via a communication interface, such as a BUS 608. DRAM is provided as an example component. Other types of memories can also be used.

In one example, the host can load a kernel functional to do some graph traversal of an unknown number of steps, for example, determining the degree of connection between two contacts in a social media network. The kernel functional can perform sparse operations, truncating the output to manage memory and perform such operations until the output is generated. The SPU is not blocked waiting on input from the host.

The SPU can be utilized in a computer system as a hardware accelerator device, for providing acceleration to the processing of sparse workloads. The SPU can be mounted on a motherboard in a computer system, where a CPU host, random-access-memory and other components of the computer system are also mounted on the same motherboard.

### System Architecture Deploying One or More SPUs

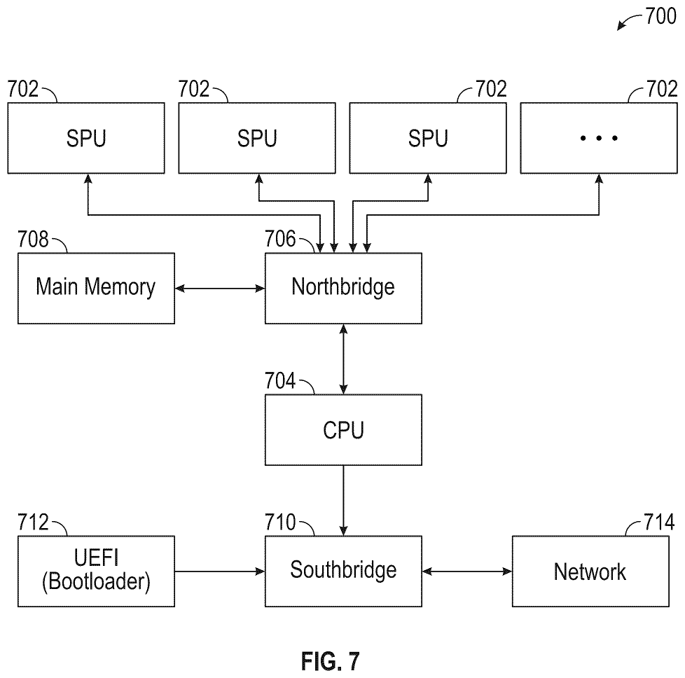

The SPUs can be deployed in a workstation computer system, where multiple SPUs are deployed to process sparse workloads. FIG. 7 illustrates a logical layout diagram of a workstation 700, where a computer system utilizes a cluster of SPUs. Not all components are shown. The workstation 700 can be utilized to accelerate the processing of large sparse workloads.

A CPU 704 can be in communication with multiple SPUs 702 via a northbridge 706. Northbridge 706 can also provide an interface to the main memory 708 for the SPUs 702 and the CPU 704. The CPU can also be in communication with other components on the motherboard, via a southbridge 710. For example, the CPU 704 can be in communication with a unified extensible firmware interface (UEFI) 712 and a network 714. In some implementations, the functionality of the northbridge and/or the southbridge may be incorporated or merged together into another components, for example into the CPU 704.

### Process Flow in an SPU-Enabled Computer System

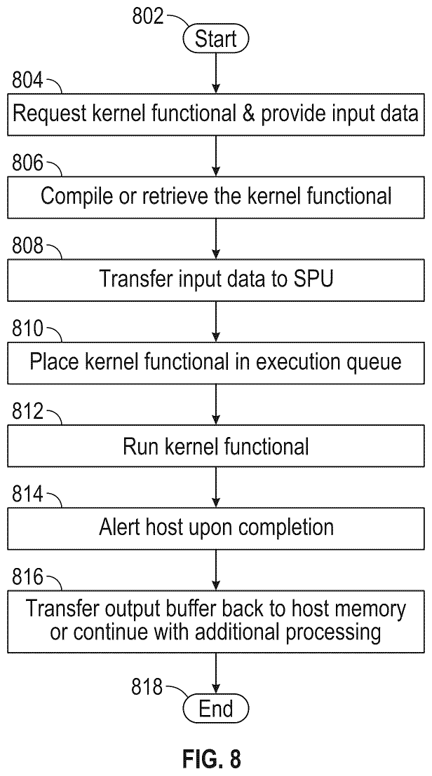

An SPU, or a cluster of SPUs can be added to a computer system, as an accelerator to increase the efficiency of the processing of sparse workloads. FIG. 8 illustrates a flowchart of an example method of processing a sparse workload in an SPU-enabled computer system. The method starts at step 802. At step 804, An application, or a program initiates execution of processing of a sparse workload, by requesting a kernel functional. The application can also provide the sparse input data. At step 806, the host, and/or an SPU driver, compiles the kernel functional, along with its dependencies. Examples dependencies of a kernel functional can include all deterministic kernels referenced by the kernel functional. Alternatively, the host and/or the SPU driver can retrieve a pre-compiled kernel functional from a cache.

At step 808, the input data is transferred to the SPU. At step 810, the kernel functional is placed in an execution queue. At step 812, the kernel functional runs, carrying out tasks programmed in the kernel functional along with memory management tasks, such as pre-calculating memory offsets, managing branching, and allocating and deallocating memory. The host CPU can carry out other tasks, while the SPU and the kernel functionals attend to the tasks programmed in kernel functional and the associated memory management. The output of execution of the kernel functional (and/or its dependencies can be temporarily stored in an output buffer memory). At step 814, upon completion of the execution of the kernel functional, the host is alerted. At step 816, the output buffer memory can be transferred back to the host memory, or used for additional processing on the SPU, and/or the host CPU. The method ends at step 818.

### Areas of Applicability

SPUs can be deployed in computer systems to help more efficiently process sparse workloads and efficiently execute programs that digest sparse workloads. Some example programs and/or workloads include graph traversal programs, sparse neural network programs, vector nearest-neighbor search programs, clustering programs, perceptrons processing programs, programs aimed at processing a layer of neurons in a neural network, neuro-evolution of augmenting topologies (NEAT) processing programs, and training a topological weight-evolving artificial neural network (TWEANN) processing programs.

### EXAMPLES

It will be appreciated that the present disclosure may include any one and up to all of the following examples.

Example 1: A computer system for efficient processing of sparse workloads, comprising:
a motherboard; a host CPU, mounted on the motherboard; a random-access-memory (RAM) module, mounted on the motherboard; and a sparse processing unit (SPU), mounted on the motherboard, and comprising: a memory management unit; a scheduler, comprising a processor, wherein the scheduler is configured to run a kernel functional, the kernel functional, configured to receive a sparse workload from the CPU, and one or more programming instructions for processing the sparse workload, wherein the kernel functional is configured to be executed by the processor of the scheduler, instructing the memory management unit to allocate and deallocate memory for the processing of the sparse workload on the RAM module; one or more parallel processors, wherein each parallel processor is configured to receive an input and an output memory allocation and/or deallocation from the memory management unit.

Example 2: The computer system of Example 1, wherein the memory management unit maps an n-dimensional sparse address space into a one-dimensional physical memory layout.

Example 3: The computer system of some or all of Examples 1 and 2, wherein the deterministic kernel comprises a graphics processing unit (GPU) kernel.

Example 4: The computer system of some or all of Examples 1-3, wherein the scheduler is a reduced instruction set computer (RISC).

Example 5: The computer system of some or all of Examples 1-4, wherein the parallel processors are implemented with a single instruction multiple data (SIM D) chip, mounted on the motherboard.

Example 6: The computer system of some or all of Examples 1-5, wherein the random-access-memory module comprises one or more dynamic random-access-memory (DRAM) modules.

Example 7: The computer system of some or all of Examples 1-6, wherein the sparse workload comprises one or more of a graph traversal program, a sparse neural network program, a vector nearest-neighbor search program, a clustering program, a perceptrons processing program, a layer of neurons in a neural network processing program, a neuro-evolution of augmenting topologies (NEAT) processing program, and training a topological weight-evolving artificial neural network (TWEANN) processing program.

Example 8: The computer system of some or all of Examples 1-7, wherein the sparse processing unit is implemented in an application specific integrated circuit (ASIC).

Example 9: The computer system of some or all of Examples 1-8, wherein the memory management unit in the sparse processing unit maps a virtual memory address space corresponding to sparse workload to a physical memory address space on the RAM module, by allocating and deallocating physical memory addresses to the parallel processors of the SPU.

Example 10: A method of accelerating sparse workloads, comprising: executing an application, the application comprising programming instructions for processing a sparse workload; requesting a kernel functional, the kernel functional, executable on a sparse processing unit (SPU), the SPU comprising: a memory management unit; a scheduler, comprising a processor, wherein the scheduler is configured to run a kernel functional, the kernel functional, configured to receive a sparse workload from the CPU, and one or more programming instructions for processing the sparse workload, wherein the kernel functional is configured to be executed by the processor of the scheduler, instructing the memory management unit to allocate and deallocate memory for the processing of the sparse workload on the RAM module; one or more parallel processors, wherein each parallel processor is configured to receive an input and an output memory allocation and/or deallocation from the memory management unit; compiling or retrieving the kernel functional; transferring sparse input data to the SPU; executing the kernel functional; and alerting the host CPU, when SPU generates a selected output.

Example 11: The method of Example 10, further comprising: mapping via the memory management an n-dimensional sparse address space into a one-dimensional physical memory layout.

Example 12: The method of some or all of Examples 10 and 11, wherein the deterministic kernel comprises a graphics processing unit (GPU) kernel.

Example 13: The method of some or all of Examples 10-12, wherein the scheduler is a reduced instruction set computer (RISC).

Example 14: The method of some or all of Examples 10-13, wherein the parallel processors are implemented with a single instruction multiple data (SIM D) chip, mounted on the motherboard.

Example 15: The method of some or all of Examples 10-14, wherein the random-access-memory module comprises one or more dynamic random-access-memory (DRAM) modules.

Example 16: The method of some or all of Examples 10-15, wherein the sparse workload comprises one or more of a graph traversal program, a sparse neural network program, a vector nearest-neighbor search program, a clustering program, a perceptrons processing program, a layer of neurons in a neural network processing program, a neuro-evolution of augmenting topologies (NEAT) processing program, and training a topological weight-evolving artificial neural network (TWEANN) processing program.

Example 17: The method of some or all of Examples 10-16, wherein the sparse processing unit is implemented in an application specific integrated circuit (ASIC).

Examples 18: The method of some or all of Examples 10-17, wherein the memory management unit in the sparse processing unit maps a virtual memory address space corresponding to sparse workload to a physical memory address space on the RAM module, by allocating and deallocating physical memory addresses to the parallel processors of the SPU.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

What is claimed is:

1. A computer system for efficient processing of sparse workloads, comprising:
a motherboard;
a host CPU, mounted on the motherboard;
a random-access-memory (RAM) module, mounted on the motherboard; and
a sparse processing unit (SPU), mounted on the motherboard, and comprising:
a memory management unit;
a scheduler, comprising a processor, wherein the scheduler is configured to run a kernel functional, the kernel functional, configured to receive a sparse workload from the CPU, and one or more programming instructions for processing the sparse workload, wherein the kernel functional is configured to be executed by the processor of the scheduler, instructing the memory management unit to allocate and deallocate memory for the processing of the sparse workload on the RAM module;
one or more parallel processors, wherein each parallel processor is configured to receive an input and an output memory allocation and/or deallocation from the memory management unit.

2. The computer system of claim 1, wherein the memory management unit maps an n-dimensional sparse address space into a one-dimensional physical memory layout.

3. The computer system of claim 1, wherein the deterministic kernel comprises a graphics processing unit (GPU) kernel.

4. The computer system of claim 1, wherein the scheduler is a reduced instruction set computer (RISC).

5. The computer system of claim 1, wherein the parallel processors are implemented with a single instruction multiple data (SIM D) chip, mounted on the motherboard.

6. The computer system of claim 1, wherein the random-access-memory module comprises one or more dynamic random-access-memory (DRAM) modules.

7. The computer system of claim 1, wherein the sparse workload comprises one or more of a graph traversal program, a sparse neural network program, a vector nearest-neighbor search program, a clustering program, a perceptrons processing program, a layer of neurons in a neural network processing program, a neuro-evolution of augmenting topologies (NEAT) processing program, and training a topological weight-evolving artificial neural network (TWEANN) processing program.

8. The computer system of claim 1, wherein the sparse processing unit is implemented in an application specific integrated circuit (ASIC).

9. The computer system of claim 1, wherein the memory management unit in the sparse processing unit maps a virtual memory address space corresponding to sparse workload to a physical memory address space on the RAM module, by allocating and deallocating physical memory addresses to the parallel processors of the SPU.

10. A method of accelerating sparse workloads, comprising:
executing an application, the application comprising programming instructions for processing a sparse workload;
requesting a kernel functional, the kernel functional, executable on a sparse processing unit (SPU), the SPU comprising:
a memory management unit;
a scheduler, comprising a processor, wherein the scheduler is configured to run a kernel functional, the kernel functional, configured to receive a sparse workload from the CPU, and one or more programming instructions for processing the sparse workload, wherein the kernel functional is configured to be executed by the processor of the scheduler, instructing the memory management unit to allocate and deallocate memory for the processing of the sparse workload on the RAM module;
one or more parallel processors, wherein each parallel processor is configured to receive an input and an output memory allocation and/or deallocation from the memory management unit;
compiling or retrieving the kernel functional;
transferring sparse input data to the SPU;
executing the kernel functional; and
alerting the host CPU, when SPU generates a selected output.

11. The method of claim 10, further comprising: mapping via the memory management an n-dimensional sparse address space into a one-dimensional physical memory layout.

12. The method of claim 10, wherein the deterministic kernel comprises a graphics processing unit (GPU) kernel.

13. The method of claim 10, wherein the scheduler is a reduced instruction set computer (RISC).

14. The method of claim 10, wherein the parallel processors are implemented with a single instruction multiple data (SIM D) chip, mounted on the motherboard.

15. The method of claim 10, wherein the random-access-memory module comprises one or more dynamic random-access-memory (DRAM) modules.

16. The method of claim 10, wherein the sparse workload comprises one or more of a graph traversal program, a sparse neural network program, a vector nearest-neighbor search program, a clustering program, a perceptrons processing program, a layer of neurons in a neural network processing program, a neuro-evolution of augmenting topologies (NEAT) processing program, and training a topological weight-evolving artificial neural network (TWEANN) processing program.

17. The method of claim 10, wherein the sparse processing unit is implemented in an application specific integrated circuit (ASIC).

18. The method of claim 10, wherein the memory management unit in the sparse processing unit maps a virtual memory address space corresponding to sparse workload to a physical memory address space on the RAM module, by allocating and deallocating physical memory addresses to the parallel processors of the SPU.
